(19) United States
(12) Patent Application Publication
(10) Pub. No.: US 2013/0298406 A1
(43) Pub. Date: Nov. 14, 2013

(54) RAZOR WITH IMPROVED SOOTHING EFFECTS DURING SHAVING

(71) Applicants: Yong Chen, Hangzhou (CN); Kenneth Davidov, Ossining, NY (US)

(72) Inventors: Yong Chen, Hangzhou (CN); Kenneth Davidov, Ossining, NY (US)

(21) Appl. No.: 13/469,381

(22) Filed: May 11, 2012

(51) Int. Cl. B26B 21/40

(52) U.S. Cl. 30/34.05

(57) ABSTRACT

A razor for shaving hairs has an ionizing device that produces ions during a shaving operation of the razor powered by a single battery. The battery can be a 1.5 Volt button battery to provide power to an ion generator that boost the voltage to about 9 Volts.

### BACKGROUND

1. Field of the Invention

The present invention is directed to a razor for shaving hairs. Specifically, the razor includes an ionizing device that produces negative ions during a shaving operation of the razor powered by a single battery

2. Related Art

Although shaving has long been practiced by men and women, often many consumers do not have a close and comfortable shave. Shaving related irritations and skin diseases are still complained of by many customers, among which, red bumps, rashes, and itching are widely reported. The irritation and skin disease related to shaving may be caused by a variety of factors, including sharpness of a blade, moisture of the hair, shaving techniques, skin diseases, and shaving creams. Various solutions have been suggested in the art to improve the shaving experience.

A commonly known solution is the use of shaving cream which reduces the wire-like hardness of the facial hair by facilitating the penetration of water through the keratin protein which accounts for 90% of the hair's weight. However, in order to account for the oil secreted from the sebaceous glands of the shaver, emulsifiers or other additives which can irritate the skin must often be added to the shaving cream.

Negative ions have been reported to have beneficial effects in many health aspects of a human body. For example, Dr. Svante August Arrhenius, a Swedish chemist who received the Nobel Prize in Chemistry in 1903, discovered that negative ions are abundant near waterfalls and forests, causing the air to be fresh. At the turn of the 20^{th} century, Nobel Prize Winner in Physics, Dr. Phillip Eduard Anton Lennard, confirmed that negative ions are found in very high density in the basin of waterfalls where we feel especially refreshed and re-energized. Negative ions have been called “Vitamins of the air.” Among all the organs, our skin absorbs 85% of charged particles from the surroundings constantly. To human health, negative ions may strengthen the functions of autonomic nerves, reinforce collagen (tissues that are resilient and tension-related), improve the permeability of the cell's prototypical plasma membranes, and also strengthen the body's immune system.

Although the use of negative ions are known in other fields and have been reported to have beneficial effects on humans which includes feelings of relaxation, reduced tiredness, stress levels, irritability, depression and tenseness, no reports are believed to be published with regard to the effects of direct application of negative ions to the skin or for their use in shaving or shaving devices (e.g. razor).

### SUMMARY OF THE INVENTION

An embodiment of the present disclosure is directed to a razor for shaving hairs. The razor includes an ionizing device that produces negative ions during a shaving operation of the razor powered by a single battery;

According to other embodiments of the present disclosure, the ionizing device is operated at 9 Volts. The razor can include a sensing section that determines whether the razor is being used. The ionizing device, the solution produced during shaving, the user's body, and the sensing section form a closed electrical circuit. The razor can include an indicator to indicate whether the razor is being used. The razor can include an attachable/detachable blade assembly. The razor can include a bottom cap to be used during a replacement of the single battery. The single battery can be, for example, a AAA battery or a button battery. The battery is disposed in a predetermined compartment and can aid in providing balance to the razor. The ionizing device may have a cylindrical shape or a planar shape.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like.

The above and other objects, features, and advantages of various embodiments as set forth in the present disclosure will be more apparent from the following detailed description of embodiments taken in conjunction with the accompanying drawings.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 illustrates a top view of a razor according to an embodiment of the present disclosure.

FIG. 2 illustrates a bottom view of a razor according to an embodiment of the present disclosure.

FIGS. 3A-3D illustrate an ionizing device according to some embodiments of the present disclosure.

FIG. 4 illustrates a block diagram of the electronic system of a razor according to an embodiment of the present disclosure.

FIG. 5 illustrates a block diagram of the oscillator circuit with voltage booster according to the present disclosure;

FIG. 6 illustrates detailed circuitry of the block diagram of FIG. 5 having an electronic switch;

FIG. 7 illustrates detailed circuitry of the block diagram of FIG. 5 having an on/off switch; and

FIG. 8 illustrates the circuitry of FIG. 6 having an AC or DC output.

### DETAILED DESCRIPTION

It will be appreciated by those ordinarily skilled in the art that the foregoing brief description and the following detailed description are exemplary (i.e., illustrative) and explanatory of the subject matter as set forth in the present disclosure, but are not intended to be restrictive thereof or limiting of the advantages that can be achieved by the present disclosure in various implementations. Additionally, it is understood that the foregoing summary and ensuing detailed description are representative of some embodiments as set forth in the present disclosure, and are neither representative nor inclusive of all subject matter and embodiments within the scope as set forth in the present disclosure. Thus, the accompanying drawings, referred to herein and constituting a part hereof, illustrate embodiments of this disclosure, and, together with the detailed description, serve to explain principles of embodiments as set forth in the present disclosure.

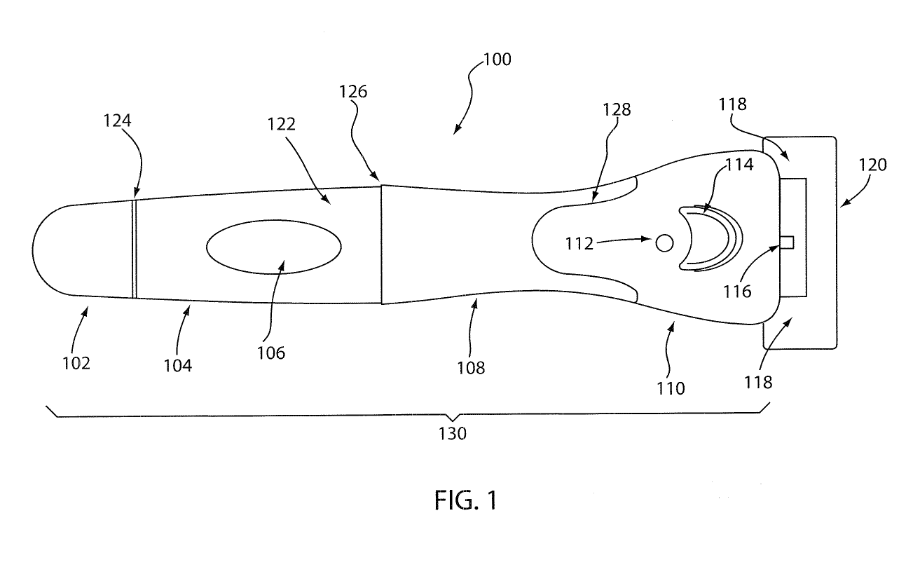

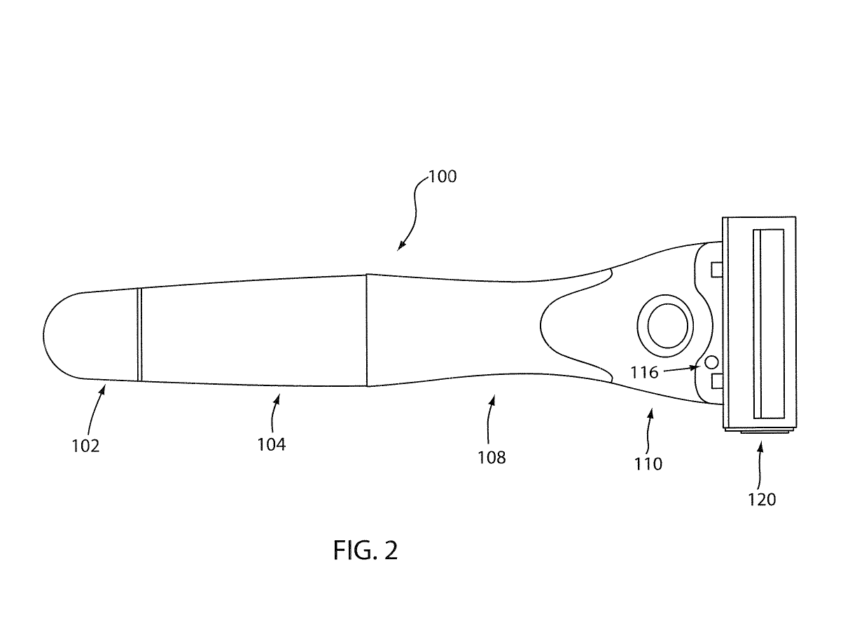

FIG. 1 illustrates a top view of a razor according to an embodiment of the present disclosure. FIG. 1 illustrates a handheld razor but other types of razors are contemplated. The razor can be used to shave, for example, a user's face, neck arms, underarms. legs or other parts of their body. Alternatively, the razor could be used on animals other than humans. FIG. 2 illustrates a bottom view of the razor in FIG. 1. The razor 100 has a detachable blade section 120 and a body section 130. The blade section 120 has one blade or a plurality of blades, which may be any commercially available blade, such as those manufactured by Gillette®. The body section 130 is formed by a plurality of parts including a bottom cap 102, a lower part 104, an upper part 108, and a top part 110. Blade section 120 is attached or secured to body section 130 through a frame work 118. Razor 100 also has an electronic system having a plurality of electrical components and functions that may improve the shaving experience of a user by, for example, reducing shaving related skin irritation. The razor according to an embodiment of the present disclosure can be operated by a single battery such as a AAA, AA battery, a button battery or other battery and is capable of producing more negative ions through an ionizing device in the vicinity of the skin area that is being shaved. The ionizing device, which can use a relatively low voltage (no more than 15 V) and may be positioned relatively far away from the follicles of hair, does not generate electrolysis, which is commonly used in an electrolysis hair removal method or device. The razor can include a state-of-the-art booster circuit to allow many other electrical or electro-mechanical functions to be operated by a single battery.

The body section 130 acts as a casing, in one aspect, for the electronic system of the razor. The bottom cap 102 is secured to the lower part 104 by screws or clips 124, forming a water-tight or water-resistant connection 124. The bottom cap may be attachable and/or detachable from the lower part 104 during a replacement of the single battery, which is placed inside the body section 130. The lower part 104 represents a housing that can protect internal components of the razor, for example, a computer chip 122 for controlling the electrical or electromechanical functions. The lower part 104 may also include a sensing part 106, which detects a status of the razor. For example, in an embodiment, the sensing part 106 detects whether a user is using the razor and provides the detection results to the computer chip 122. The sensing part 106 may also detect a current running through the ionizing device, which indicates a number of negative ions produced by the razor. The sensing part 106 may be formed by a simple conductor or may be a switch or may be an optical sensor. The lower part 104 may be connected to the upper part 108 through another water-tight or water-resistant connection 126. The upper part 108 provides a compartment to a power source, which may be a single AAA battery (about 1.5 V) or a single button battery (about 1.5 V). The power source is placed in the upper part 108 so that the razor has a proper balance in the user's hand during use. The upper part 108 may be connected with the head part 110 through another water-tight or water-resistant connection 128.

It is noted that bottom cap 102, lower part 104, upper part 108, and head part 110 do not need to be individual pieces that are manufactured separately. Some of these parts may be combined to form a single piece under certain situations. For example, if an externally rechargeable battery is used by the razor, bottom cap 102, lower part 104 and upper part 108 may be a single piece because no replacement of the battery is required. When a single button battery is used and placed at bottom cap 102, then lower part 106 and upper part 108 may be a single piece. It is also noted that a plurality of batteries may be used as the power source of the razor.

On a surface of head part 110, an indicator 112 may be positioned, which illuminates or flashes lights when the razor is in use. In an embodiment, indicator 112 may illuminate lights of different colors based on the number of negative ions generated. For example, when a user turns on the razor, indicator 112 may illuminate a green light indicating a low level of negative ions. When the user starts shaving, indicator 112 may illuminate a blue light indicating a higher level of negative ions. It is also possible for the razor to have a plurality of indicators 112 or indicate the number of ions by intensity of the illumination. The location of indicator 112 is not limited to the location as shown in FIG. 1. The indicator 112 may also be placed at both sides of the head part 112 or on the lower cap 102. Indicator 112 may represent an optical film that is on the surface of upper part 108.

The release button 114 is used to release the blade 120 from the framework 118. Mechanisms of the release button and corresponding structures are known to a person of ordinary skill in the art.

The ionizing device 116 is typically made of conductive materials, which allows electrons to pass to the surrounding mediums such as air, hair, shaving cream, or water or the mixture of shampoo and water. The ionizing device 116 may be negatively charged with a DC voltage. The voltage may be in the range between 1.5 V to 50 V. In an embodiment, the voltage is below 15 V, such as 3 V, 6 V, 9 V or 12 V, or some other voltage. Ionizing device 116 is positioned on the surface of one end of head part 112 and behind blade assembly 120. Such a placement can ensure that the ionizing device does not directly contact with the skin and keeps a distance from the hair follicle in order to prevent a production of electrolysis in the saline of the hair follicle.

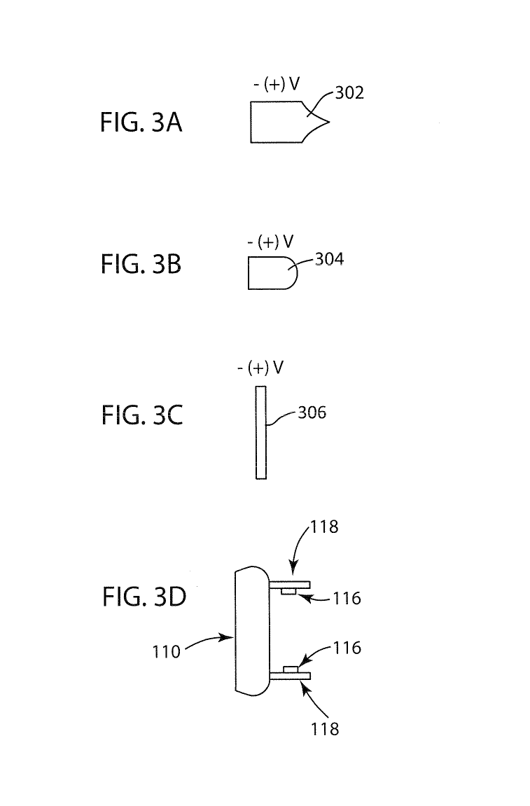

Ionizing device 116, as shown in FIG. 1 and FIG. 2 has a cylindrical shape. It may have other shapes as shown in FIGS. 3A-3D. Ionizing device 116 may have a sharp tip 302 as shown in FIG. 3A or may have a rounded end 304 as shown in FIG. 3B. The ionizing device 116 may also have a planar shape 306 as shown in FIG. 3C. Alternatively, ionizing device 116 may have a shape that combines the various embodiments in FIGS. 3A-3C. The ionizing device 116 may also be placed on legs 118 rather than the end of head part 110. It is noted that any other shapes that may be contemplated by a person of ordinary skill in the art for an ionizing device are within the scope of the present disclosure.

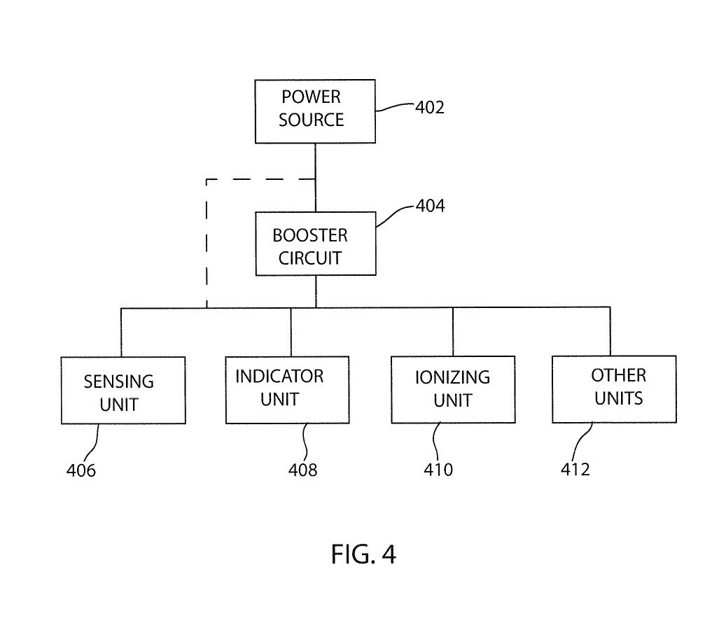

FIG. 4 illustrates a block diagram of the electronic system of a razor according to an embodiment of the present disclosure. The electronic system of the razor may include a power source 402, a booster circuit 404, a sensing unit 406, an indicator unit 408, an ionizing unit 410, and other units 412. Power source 402 may be a single AAA battery or a single button battery, which reduces the weight and cost of the razor compared to razors requiring more than one battery. Alternatively, the power source may use a single rechargeable battery. The electronic system also has a booster circuit 404 to increase the voltage of a battery to a desired level. The booster circuit 404 will be described in detail in later part of the present disclosure. The power source 402 may also bypass the booster circuit 404 to output electrical powers directly to other electronic circuits or units depending on the voltage requirement of each circuit or unit.

Sensing unit 406 determines whether the razor is being used and transmits a sensing signal to the computer chip for controlling other circuits and units. Sensing unit 406 includes the sensing part 106, which may be, for example, a simple switch, an optical sensor, or an electrical circuit and can control the application of battery power to circuitry that generates ions. When a simple switch is used as the sensing unit 406, the computer chips controls other units when the user turns on the switch. When an optical sensor is used, the computer chip controls other units when the optical sensor is blocked. An electrical circuit may also be used as the sensing unit. Sensing unit 406 may also detect the amount of current passing through the ionizing device 116, which can be used to control the color or intensity of the indicator 112.

The indicator unit 406 reminds the user about the status of the electronic system by illuminating or flashing light through the indicator 112. For example, when the user is using the razor, the red light or blue light is kept on. The indicator unit 106 may illuminate light of different colors depending on the current detected by the sensing unit 406.

Ionizing unit 410 is connected with the booster circuit 404 so that the ionizing unit receives a DC voltage of 9 V or 12 V. The ionizing unit 410 is designed to produce negative ions within the vicinity of the shaving area through a plurality of mechanisms. Upon using the razor, a user makes contact with the lower part 104 of the razor, therefore connecting the contacts of the sensing part 106. At this stage, the ionizing unit 410 may produce negative ions in the air. Because the air is also an insulator, the number of negative ions generated during this stage is relatively low compared with the level of ion production in the next step. After the user applies shaving cream and starts shaving, an electronic circuit is formed by the ionizing device 116, the mixture of shaving cream and water (an electrolyte-like solution), the user's hand, and the sensing unit 106.

Electrons start to flow from the ionizing device 116 to the shaving cream, generating more negative ions. Because the ionizing device 116 is negatively charged, negative ions in the mixture of the shaving cream and water are repelled away from the ionizing device 116 and toward the shaving area. The voltage may also cause certain electrochemical reactions in the mixture, generating more negative ions. It is believed that the negative ions reduce the irritation during shaving and make users feel a better soothing effect by using the razor as set forth in the present disclosure. Because the human body and the cream mixture do not have a low resistance, the current running through the circuit is very small, such as in the range of a few milliamps or even a few microamps, which is considered safe for this application. It is believed that no appreciable electrolysis occurs in the saline of the hair follicle due to the low voltage applied to ionizing device 116 and the distance between ionizing device 116 and the skin.

The other units 412 may include a vibrator, which produces vibration of high frequency and small amplitude during shaving. The other units 412 may also include a beeper that produces a warning when the power of the battery is low.

The booster circuit 404 has similar features as that described in U.S. application Ser. No. 13/456,272 to Chen filed Apr. 26, 2012, the entirety of which is incorporated herein by reference. The booster circuit 404 is described in detail in the following section. In these discussions the terms “on”, “saturated mode” and “saturation” as applied to a transistor are used interchangeably to mean a transistor in the ON state as is commonly understood by those of ordinary skill in the art. The terms “off”, “cutoff mode” and “cutoff” as applied to a transistor are used to mean a transistor in the OFF state as is commonly understood by those of ordinary skill in the art. The term “inductor”, “coil” and “inductive element” are used interchangeably.

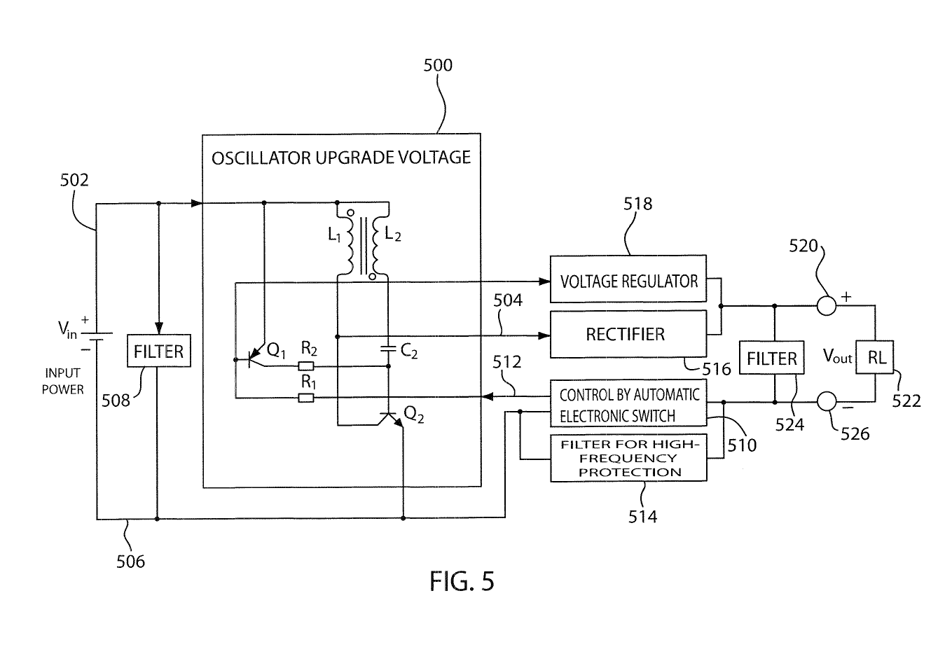

FIG. 5 illustrates an oscillator circuit with voltage booster 500 (“oscillator/booster”) for converting a direct current (DC) input voltage Vin provided on a line 502 to an oscillating output voltage Vosc on a line 504. As described later, Vosc 504 will have a greater peak voltage level than Vin 502. Vin 502 has a return on common line 506 (“common”). An input filter 508 may be placed across the DC input voltage. In an embodiment, operation of the oscillator/booster 500 may be started using an electronic switch 510. As discussed herein below, electronic switch 510 may start the oscillator/booster 500 by providing a starting voltage Vstart on line 512 to the oscillator/booster. A high frequency filter 514 can be placed across the electronic switch 510 to filter high frequency electrical noise developed, for example, in the switching circuitry to avoid undesired starting of the oscillator/booster. Vosc 504 can be provided to a rectifier 516, which provides rectified Vosc as an output voltage Vout on a line or terminal 520 to a load RL 522. Vout 520 can also be provided to a voltage regulator 518 for controlling the peak voltage level of Vosc 504 from the oscillator/booster. Rectified Vosc, which is equivalent to Vout 520, may also be filtered by an output filter 524.

Circuitry of the Electronic Switch:

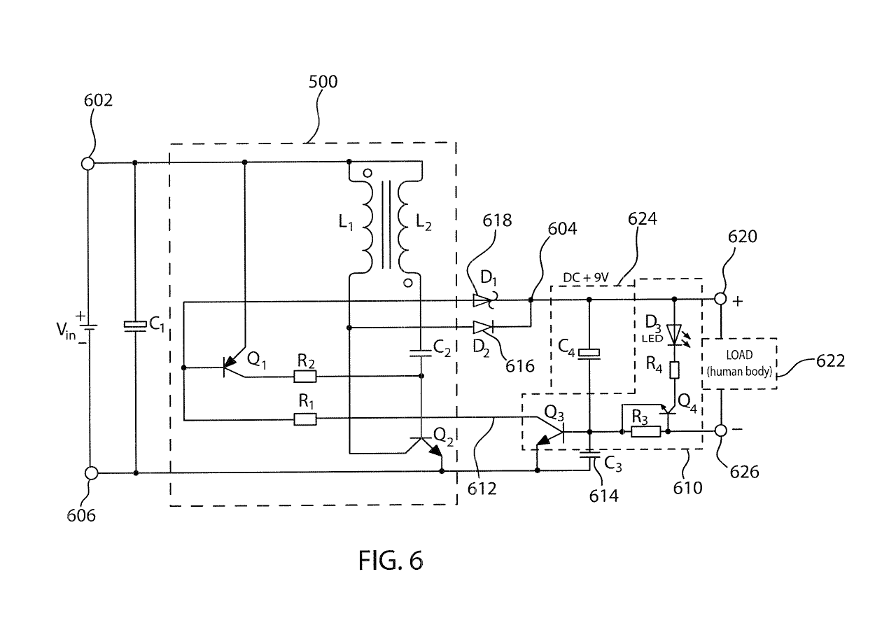

FIG. 6 illustrates an embodiment of the oscillator/booster 500 of the present disclosure having an electronic switch 610. A connection of load RL 622 can start the operation of the oscillator/booster 500. The connection of RL 622 can cause starting voltage Vstart 612 to switch the oscillator/booster on by, for example, a return to common 606 for a switch inside of the oscillator/booster. Of course, Vstart 612 could also provide a voltage to a switching circuit inside of the oscillator/booster or other technique. In an implementation, RL 622 is a user touching Vout 620 to a Vout return terminal 626, which is connected to electronic switch 610. In this case, current can flow through the resistance of the user's body to activate the electronic switch.

In an implementation, electronic switch 610 includes a transistor Q3 having a base connected through a resistor R3 to Vout return terminal 626. A collector of Q3 is connected to Vstart 612. Optionally, an indicator D3 can be activated when a load RL 622 is coupled between Vout terminal 620 and Vout return terminal 626. Indicator D3 can be a light-emitting diode (LED), sound device, vibration device or any suitable well-known indicator. Indicator D3 can be connected through a resistor R4 to a collector of transistor Q4. An emitter of Q4 is connected to the base of Q3 and a base of Q4 is connected to Vout return terminal 626.

Circuitry of the Oscillator/Booster:

FIG. 6 illustrates an embodiment of an oscillator circuit with a voltage booster according to the present disclosure. The oscillator/booster circuitry includes a boost inductor L1 that is magnetically coupled to an oscillating inductor L2. That is, inductors L1 and L2 are two closely spaced coils with opposite windings and may be wound on a common core. The common connection point of inductors L1 and L2 is connected to an input voltage 602 (Vin+). The remaining terminal of oscillating inductor L2 is connected in series with an oscillating capacitor C2, which is then connected to the base of transistor Q2. The collector of transistor Q2 is connected to the remaining terminal of L2 and the emitter of transistor Q2 is connected to the input voltage return 606 (Vin−) or common.

A transistor Q1 has an emitter connected to the input voltage 602 and collector connected through a resistive element R2 to the junction of oscillating capacitor C2 and base of transistor Q2 the base of transistor Q1 is connected through a resistive element RI to Vstart 612. A low voltage applied at Vstart 612 will turn transistor Q1 on. In an implementation, transistor Q1 is a PNP-type transistor such as S8550 and transistor Q2 is an NPN-type transistor such as S8050.

When in operation, the oscillating voltage will appear at the junction of the collector of transistor Q2 and the inductor L1. A rectifier 616, such as a diode, can be connected to the oscillating voltage to rectify the oscillating voltage. The rectified voltage can also be regulated by a regulator 618. In an implementation of a regulator, a zener diode is placed between the oscillating voltage at the cathode of the rectifier and the base of transistor Q1. In this way, an overvoltage condition at Vosc 604 can affect transistor Q1 and transistor Q2 to decrease voltage Vosc 618.

The circuit uses separated coils L2, L1 to oscillate and boost up the input voltage. The circuit has the advantage of enabling a change in the oscillating frequency and voltage level by changing the number turns on coils L2, L1. Changing the output voltage level can be achieved by changing the number of turns of coil L1. The oscillating frequency can be changed by changing the number of turns on coil L2 (or changing the capacitance of capacitor C2). For example, decreasing the number of turns on coil L2 and decreasing the capacitance of capacitor C2 will increase the frequency of oscillation. That is, a desired frequency can be established by adjusting the feedback. In this way, it is easy to adjust the circuit for a desired oscillating frequency and oscillating conditions to provide a desired output voltage and current. The efficiency of the circuit increases as the oscillating frequency increases, but the output current will decrease. The circuit has the advantage of greater stability, higher efficiency and easier oscillation than oscillator/booster circuits using only a single coil.

The oscillator/booster circuit has an advantage of providing a boosted voltage output from a lower DC input voltage. In an implementation, Twin Tank Circuit (electronic component L1, L2) boost a standard 1.2-1.5 VDC disk battery into 9-12V for application to a load. This is an advantage, for example, in electrical devices requiring a higher voltage and having a small space because additional disk batteries can be prohibitively large. Moreover, a single battery may be advantageous for products that are not disposable. That is, products in which the batteries are replaceable, such as a razor, that are expected to last longer when blades are replaced. In such a case, a user may be reluctant to purchase a product requiring six 1.5 V batteries.

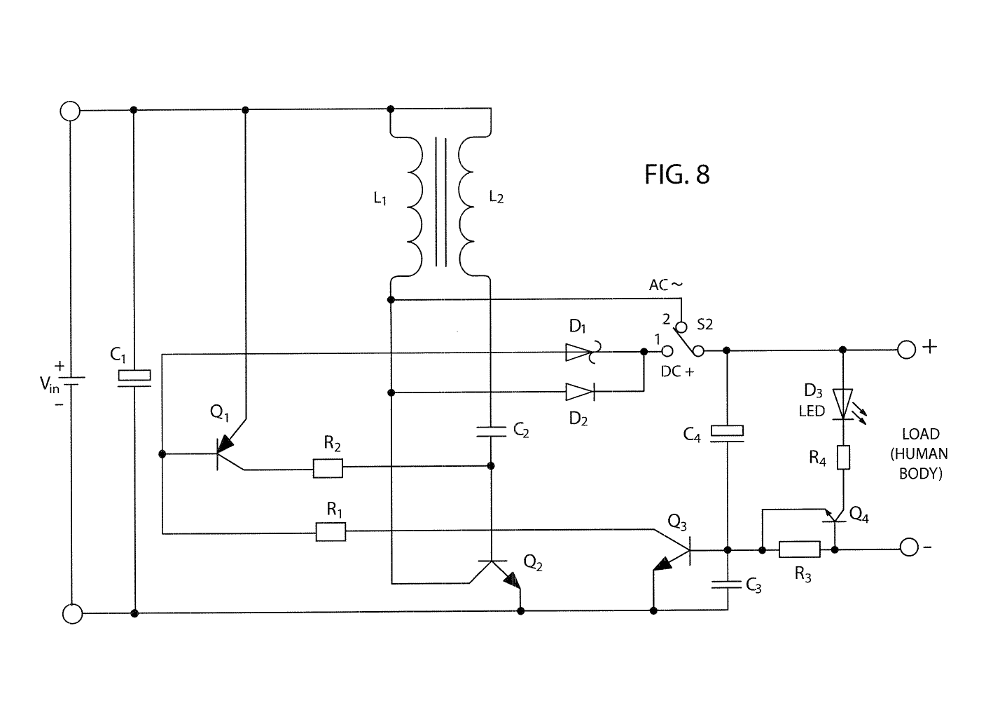

FIG. 8 illustrates a variation of the circuitry of FIG. 6 that can provide either an alternating current (AC) or direct current (DC) output, Vout. A switch S2 is provided at the junction of rectifier diode D2 and regulator D1. Switch S2 is connected so that when in a first position (1), then regulated and rectified DC voltage from the junction of D2 and D1 is provided to the output voltage Vout. When switch S2 is in a second position (2), then AC pulsed voltage is provided from the collector of Q2 to the output voltage Vout.

The AC pulsed voltage could change the structure and energy of germs on the skin in order to aid in sterilization. During the output of the AC, besides the possible aided sterilization function, the pulsed power may increase membrane permeability of the skin cell, which can be a benefit for the skin of the user.

Operation of the Electronic Switch:

In operation, connection of load RL 622, a user touching Vout terminal 626 at the same time as Vout return terminal 626, for example, enables a current to flow from Vin 602 through inductor L1 and rectifier diode 616 to the base of Q3 through R3 to turn on transistor Q3. Transistor Q3 on provides a low resistance path for Vstart 612 to common line 606. As discussed herein below, the low resistance path for Vstart to common line 606 can be used to start the oscillator/booster 500.

Connection of RL can also provide current to the base of transistor Q4 to turn on transistor Q4, which, in turn, draws current through, and activates, indicator D3. A capacitor 614 (C3) across the base-emitter junction of Q3 is a high frequency filter.

When the output terminal of the oscillator/boost circuit is not connected to load RL 622, there is no electrical current at the base of Q3 and Q3 is off. Q3 being off keeps transistors Q1 and Q2 off. Accordingly, when RL is not applied the oscillator/booster does not consume any power. As such, a separate mechanical switch to turn on power is not necessary.

Operation of the Oscillator/Booster Circuit:

As discussed herein above, when a load RL 622 is present across terminals 620, 626, electronic switch 610 operates to start the oscillator/booster. That is, transistor Q3 goes from off to on and the collector and emitter of transistor Q3 may be considered as connected. With transistor Q3 on, current will be drawn through resistor R1 and the emitter-base junction of transistor Q1 turning on transistor Q1. When transistor Q1 is on, the collector and emitter of transistor Q1 may be considered as connected and a current will flow through resistor R2 to the base of transistor Q2 turning on transistor Q2. When transistor Q2 is on, the collector and emitter of transistor Q2 can be considered connected and the voltage Vin 602 will be applied across inductor L1. Current will flow through inductor L1 causing storage of energy in the concurrent magnetic field developed in inductor L1. At the same time a current is induced in inductor L2 because inductor L2 is magnetically coupled to inductor L1 (inductors L1 and L2 are two closely spaced coils with opposite windings).

The current induced in inductor L2 will charge capacitor C2 toward Vin 602 and the potential on resistor R1 and resistor R2 will decrease as the current charges capacitor C2. As capacitor C2 charges, transistors Q2 and Q1 will go from an on state back into cutoff and capacitor C2 will discharge.

As transistor Q2 enters cutoff, an inductive back voltage is produced by inductor L1, which is higher than the input voltage Vin 602, due to the decrease in current flow though inductor L1 and the concurrent collapse of the magnetic field and release of stored energy. The inductive back voltage is negative on top and positive on the bottom (of inductor L1 as illustrated) and is in parallel with input voltage Vin 602 and current will flow through rectifier diode D2 to charge output filter capacitor 624 to Vosc 604.

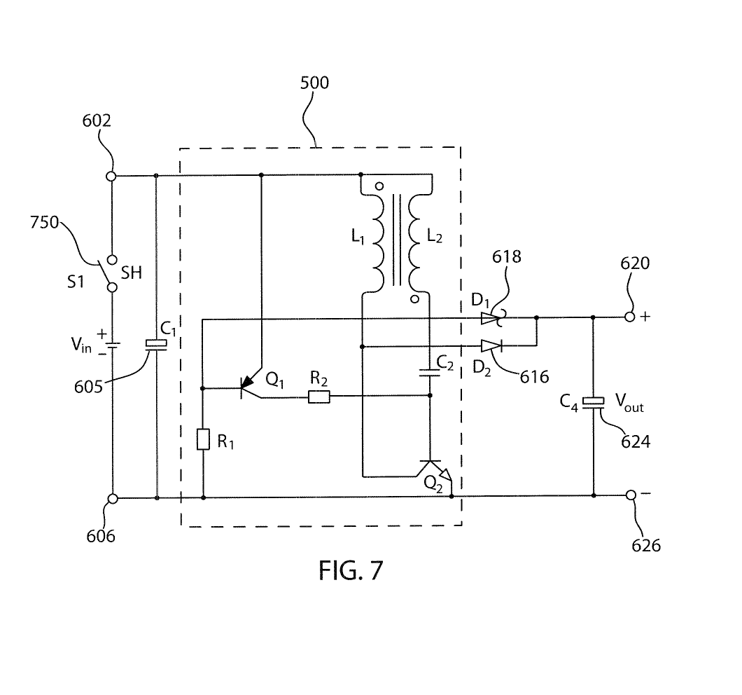

The process will repeat as long as transistor Q1 can go into an on state, whether by action of the electronic switch 610 as discussed above or by another technique such as described herein with respect to an alternative implementation of FIG. 7.

Regulator diode D1 can be used to assure that Vosc 604 does not exceed a specified voltage. In an implementation, regulator diode D1 is a zener diode having the specified breakdown voltage. Should Vosc exceed the specified voltage, regulator diode D1 will breakdown and limit the value of Vosc by providing a current path through resistor R1 and transistor switch Q3 (which is in the on state when the oscillator booster is operating) to Vin common 606. The excess potential on resistor R1 will increase and, when exceeding a threshold, will drive transistor Q1 into cutoff causing transistor Q2 into cutoff as well until the voltage on R1 decreases to permit transistor Q1 to return to the saturated state.

Without rectifier diode D2, the duty cycle of voltage Vosc of the oscillator/booster is 50%, which indicates that transistor Q1 and Q2 are in cutoff half of the time. Regulator diode D1 can make the output of the oscillator/booster Vosc more stable.

Adjusting the impedance values of R1 changes the value of the output current. Of course, transistors Q1 and Q2 may need higher current carrying capacity as well, as is commonly understood by those of ordinary skill. Adjustment of the breakdown voltage of D1 and the inductance values of coils L1 change the value of the output voltage of the oscillator/booster Vosc.

FIG. 7 illustrates an oscillator/booster having a switching device 750 rather than the automatic electronic switch 610 of FIG. 6. The operation of the oscillator/booster of FIG. 7 is substantially the same as in FIG. 6. In this implementation, the base of transistor Q1 is connected through resistive element R1 to common line 606, rather than to an electronic switch. Accordingly, transistor Q1 will go into the on state when switching device 750 connects input voltage Vin to the circuit, regardless of whether a load is applied across terminals 620, 626. Moreover, output voltage Vout return terminal 626 is also connected to input voltage return 606. Switching device 750 can be any appropriate device including a toggle, slide, pressure or bat switch. With transistor Q1 in the on state, the circuit operates substantially the same as described above with respect FIG. 6.

User Experience and Possible Explanations For the Improved Soothing Effect.

The ionic razors of the invention were tested for their effectiveness in shaving of facial hair. A 21 year old male with a thick beard and a history of pimples & acne in the chin & mouth areas shaved using the ionic razor as depicted in FIGS. 1 and 2 over a one month period of time. Improvement from using the ionic razor over a one month period of time was observed as compared to shaving under the same conditions with currently commercially available razors. The user's skin was cleaner with the pimples and acne mostly gone and general improvement of overall facial appearance. A 50 year male with a history of razor burn (red face) after shaving and having some pimples in the neck area used the razor as depicted in FIGS. 1 and 2 over a one month period of time. The person's skin was lighter after shaving with no razor burn (or red face) and he felt energetic and upbeat after shaving. Without being bound to theory, applicants believe the abundance of negative ions present during the shaving experience results not only improved skin appearance, but boosted the user's stamina and made him feel less tired throughout the day.

Users have recognized that the razor makes the skin feel cleaner, improves existing blemishes, reduces razor burn (red face), and enhances overall appearance. While not wishing to be bound by a particular theory or mechanisms, it is believed that such soothing effect is mainly the benefit of negative ions. The razor may generate the negative ions that are directed toward the pores and sweat glands of the skin and cause an expansion of these openings that increases the surface area of the hair being cut and decreases the surface area of the skin being exposed to the razor. It is also hypothesized that the increase in metabolism associated with negative ions directed to the skin also accelerates the recovery of the skin from the trauma delivered to skin during shaving.

Throughout the specification and claims, the following terms take at least the meanings explicitly associated herein, unless the context dictates otherwise. The meanings identified below do not necessarily limit the terms, but merely provide illustrative examples for the terms. In the text, the terms “comprising”, “comprise”, “comprises” and other forms of “comprise” can have the meaning ascribed to these terms in U.S. Patent Law and can mean “including”, “include”, “includes” and other forms of “include.” The term “contains” or other forms thereof, as used herein, is synonymous with “comprises” or “includes”; it is similarly inclusive or open-ended and does not exclude additional, unrecited elements or steps. The term “composed” or other forms thereof, as used herein, denotes that some embodiments or implementations may exclude unspecified materials, compounds, elements, components, or the like (e.g., other than, for example, impurities, trace compounds, or the like), and that some embodiments may not exclude other unspecified materials, compounds, elements, components, or the like; for example, other unspecified materials, compounds, elements, may be included provided they do not adversely affect the desired characteristics of the specified material, compound, element, component, or the like, or otherwise do not materially alter the basic and novel characteristics of the embodiment or implementation.

The phrase “an embodiment” as used herein does not necessarily refer to the same embodiment, though it may. In addition, the meaning of “a,” “an,” and “the” include plural references; thus, for example, “an embodiment” is not limited to a single embodiment but refers to one or more embodiments. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise.

While this invention has been described in conjunction with the specific embodiments outlined above, it is evident that many alternatives, modifications, and variations will be apparent to those ordinarily skilled in the art. Accordingly, the preferred embodiments of the invention as set forth above are intended to be illustrative, not limiting. Various changes may be made without departing from the spirit and scope of the inventions as defined in the following claims.

What is claimed is:

1. A razor for shaving hairs of a user; comprising:
an ion generator;
an ion emitter on a housing of the razor; and
a controller to cause the ion generator to provide ions to the ion emitter when the user is shaving.

2. The razor of claim 1, comprising:
a touch contact on the housing of the razor;
wherein, the controller determines a user is shaving when an electrical connection is made between the touch contact and the ion emitter.

3. The razor of claim 2, wherein the ion generator is an oscillator circuit with a voltage booster to convert an input from a single 1.5 Volt button battery to about 9 Volts.

4. The razor of claim 3, comprising an indicator to indicate that the ion generator is generating ions.

5. The razor of claim 4, wherein the indicator illuminates when the ion generator is generating ions.

6. The razor of claim 5, wherein an intensity of the indicator illumination is dependent on a number of ions being generated.

7. The razor of claim 5, wherein a color of the indicator illumination is dependent on a number of ions being generated.

8. A razor for shaving hairs of a user, comprising:
a housing to house a single battery;
an ion emitter on the housing;
a touch contact on the housing;
an ion generator disposed within the housing and connected to the ion emitter, the ion generator enabled to provide ions to the ion emitter; and
a controller to provide power from the single battery to the ion generator to cause the ion generator to generate ions.

9. The razor of claim 8, wherein the controller is a first switch.

10. The razor of claim 8,
wherein the controller includes circuitry to determine when the user is shaving and, in response, provide power to the ion generator, and
wherein the controller determines the user is shaving when a resistance between the touch contact and the ion emitter is below a predetermined value.

11. The razor of claim 10, wherein the battery is a 1.5 Volt button battery.

12. The razor of claim 11, wherein the ion generator includes a voltage oscillator and booster circuit that converts the 1.5 Volt battery voltage to between about 3 Volts and about 15 Volts.

13. The razor of claim 12, wherein the ion generator converts the 1.5 Volt battery voltage to about 9 Volts.

14. The razor of claim 12, wherein the ion generator includes a second switch to switch between providing ions in a direct current (DC) voltage and an alternating current (AC) to the ion emitter.

15. The razor of claim 13, comprising an indicator that illuminates when the ion generator is generating ions.

16. The razor of claim 15, wherein an intensity of the indicator illumination is dependent on a number of ions being generated.

17. The razor of claim 15, wherein a color of the indicator illumination is dependent on a number of ions being generated.

18. The razor according to claim 10, wherein the ion emitter has a cylindrical shape.

19. The razor according to claim 10, wherein the ion emitter has a planar shape.

20. A method of providing ions to a user during shaving with a razor, comprising:
housing a single 1.5V button battery in a housing of the razor;
emitting ions from an ion emitter disposed on the housing;
disposing a touch contact on the housing; and
generating ions by an ion generator disposed within the housing,
wherein the ion generator is connected to the ion emitter, the ion generator enabled to generate ions when power is provided to the ion generator from the single battery 1.5V button battery.

21. The razor of claim 20, comprising controlling power to the ion generator with a switch.

22. The razor of claim 20, comprising:
determining when a resistance between the touch contact and the ion emitter is below a predetermined value; and
providing power to the ion generator when the resistance is below a predetermined threshold.
